(19) United States
(12) Patent Application Publication
(10) Pub. No.: US 2025/0368491 A1
(43) Pub. Date: Dec. 4, 2025

(54) BLOCKING DEVICE FOR A CYLINDER AND HANDLING MACHINE WITH LIFTING ARM COMPRISING THE BLOCKING DEVICE

(71) Applicant: MANITOU BF, ANCENIS (FR)

(72) Inventors: Alexis POUSSET, ANCENIS (FR); Christian GUILLOU, ANCENIS (FR)

(21) Appl. No.: 18/861,671

(22) PCT Filed: May 2, 2023
(86) PCT No.: PCT/EP2023/061561

§ 371 Date: Aug. 18, 2025

(30) Foreign Application Priority Data
May 3, 2022 (FR) FR2204212

(51) Int. Cl. B66F 17/00; B66F 9/065; F15B 15/24

(52) U.S. Cl. CPC B66F 17/003; B66F 9/0655; F15B 15/24

(57) ABSTRACT

The invention relates to a blocking device (20) for a lifting cylinder (6) and to a handling machine (1) with lifting arm (5).

The blocking device (20) comprises two blocking elements (30, 40).

The two blocking elements (30, 40) are configured to be assembled to one another in an assembled configuration in which the two blocking elements (30, 40) together delimit a central space through which the rod (62) of the lifting cylinder (6) passes. The blocking device (20) blocks a movement of the lifting arm (5) towards its lower position.

### TECHNICAL FIELD

The invention relates to the field of handling machines with lifting arm. More precisely, the invention relates to a handling machine with lifting arm comprising a blocking device for blocking a movement of the lifting arm towards its lowered position. The invention also relates to a blocking device for a cylinder.

### TECHNICAL BACKGROUND

A handling machine comprising a lifting arm is known, for example, from document WO 2021/170929 A1. The lifting arm is pivotably mounted on the chassis of the handling machine about an axis of rotation, in such a way as to be movable in a vertical plane between a lowered position and a raised position. The handling machine comprises a lifting cylinder articulated to the lifting arm in order to rotate the lifting arm.

### SUMMARY

In such a handling machine, it may be desired to block a movement of the lifting arm towards its lowered position, for example in order to allow an operator to act without danger on a part of the handling machine which is located under the lifting arm.

In order to produce this blocking of the movement of the lifting arm towards its lowered position, it may be envisioned to dispose a blocking packing-piece on the lifting cylinder, the blocking packing-piece consisting of a single piece with a U-shaped profile and having a predetermined length. When the lifting cylinder is retracted to the predetermined length, the blocking packing-piece abuts, at one of its ends, against the barrel of the lifting cylinder, and at the other of its ends against the lifting arm, and thus prevents the retraction of the lifting cylinder to below the predetermined length.

However, the inventors have observed that this solution is not entirely satisfactory.

In particular, the blocking packing-piece can have large dimensions, to the extent of making its positioning on the handling machine difficult, or even very difficult, if the handling machine is small. However, it is crucial that the blocking packing-piece can be fixed somewhere on the handling machine while remaining easily accessible.

In addition, being formed of a single piece, the blocking packing-piece has a large mass which makes its positioning on the lifting cylinder difficult.

An idea underlying the invention is to propose a handling machine comprising a blocking device for blocking a movement of the lifting arm towards the lowered position, the blocking device being easy to assemble and of limited dimensions.

According to a first subject, the invention provides a blocking device for a cylinder, the blocking device comprising two blocking elements, each blocking element having a first end and a second end opposite the first end, wherein the two blocking elements are configured to be assembled to one another in an assembled configuration in which the two blocking elements together delimit a central space for a rod of the cylinder,
wherein, in the assembled configuration, a distance between the first end and the second end of a blocking element defines a minimum extension of the cylinder, said minimum extension of the cylinder being attained when a) the first end of each of the two blocking elements abuts against an end surface of a barrel of the cylinder in which the rod slides, and b) the second end of each of the two blocking elements abuts against an articulation bracket, the articulation bracket receiving an articulation shaft, an opposite end of the rod from the barrel being mounted articulated to the articulation shaft.

According to a second subject, the invention provides a handling machine comprising:
a chassis that can move relative to the surface of the ground;
a lifting arm pivotably mounted on the chassis about an axis of rotation, in such a way as to be movable between a lowered position and a raised position;
a lifting cylinder for pivoting the lifting arm, the lifting cylinder including: a barrel mounted articulated to one of the chassis and the lifting arm, about a first articulation axis; and a rod mounted to slide in the barrel and mounted articulated to the other of the chassis and the lifting arm via an articulation shaft, the articulation shaft extending along a second articulation axis parallel to the first articulation axis and being received in an articulation bracket which the other of the chassis and the lifting arm has; and
a blocking device for blocking a movement of the lifting arm towards the lowered position,
wherein the blocking device comprises two blocking elements, each blocking element having a first end and a second end opposite the first end, wherein the two blocking elements are configured to be assembled to one another in an assembled configuration in which the two blocking elements together delimit a central space through which the rod passes,
wherein, in the assembled configuration, the first end of each of the blocking elements abuts against an end surface of the barrel, and the second end of each of the two blocking elements is configured to abut against the articulation bracket in such a way as to block said movement of the lifting arm towards the lowered position.

Through these features, the blocking device can be easily produced by assembling the two blocking elements to one another around the rod of the lifting cylinder. In addition, for a lifting cylinder of given dimensions, the two blocking elements can have dimensions smaller than those of a blocking packing-piece formed as a single piece with a U-shaped profile, which facilitates the positioning of the blocking elements on the handling machine.

According to some embodiments, such a handling machine can include one or more of the following features.

According to an embodiment, the barrel is mounted articulated to the chassis about the first articulation axis, and the rod slidingly mounted in the barrel is mounted articulated to the lifting arm via the articulation shaft, the articulation shaft extending along the second articulation axis.

According to an embodiment, the first articulation axis is parallel to the axis of rotation of the lifting arm.

According to an embodiment, the lifting arm is movable in a vertical plane.

According to an embodiment, the vertical plane is parallel to a longitudinal direction of the handling machine.

According to an embodiment, the two blocking elements have a generally L-shaped cross-section.

According to an embodiment, each of the two blocking elements includes at least one tenon, said at least one tenon being intended to be received in a mortise included in the other blocking element, in such a way as to produce the assembled configuration.

Thus, the assembly of the blocking device is particularly easy to carry out and does not require a tool.

According to an embodiment, each of the two blocking elements includes three tenons, said three tenons comprising a retaining tenon, the retaining tenon having a through-hole configured to receive a pin for retaining the two blocking elements in the assembled configuration.

According to an embodiment, each of the two blocking elements further includes at least one aperture.

This lightens the two blocking elements and thus further facilitates the assembly of the blocking device.

According to an embodiment, at least one of the two blocking elements includes, at its second end, an attached plate configured to abut against the articulation bracket.

According to an embodiment, said attached plate is attached by welding. According to an embodiment, the two blocking elements are identical.

This facilitates the manufacture of the blocking device. In addition, the assembly of the blocking device is facilitated because the user is not required to make a distinction between two blocking elements which are different.

According to an embodiment, each of the two blocking elements is configured to be fixed to the chassis.

According to an embodiment, the chassis includes two side-members extending parallel to one another, the lifting arm being pivotably mounted between the two side-members.

According to an embodiment, the side-members extend parallel to the longitudinal direction of the handling machine.

According to an embodiment, at least one of the blocking elements, and preferably both blocking elements, are configured to be fixed to the chassis in a space located between the two side-members, under the lifting arm when the lifting arm is in the lowered position.

Each of the features presented above in relation with the handling machine according to the second subject is also applicable to the blocking device according to the first subject.

The blocking device according to the first subject can be used for blocking a lifting cylinder incorporated in a handling machine or any other cylinder.

### BRIEF DESCRIPTION OF THE FIGURES

The invention will be better understood and other details, features and advantages of the invention will appear more clearly in the course of the following description of several particular embodiments of the invention, given by way of illustration only and non-limiting, with reference to the accompanying drawings.

FIG. 1 is a schematic representation of a handling machine in the form of a lift truck.

FIG. 2 is a perspective view of a blocking device for blocking a movement of the lifting arm of the lift truck of FIG. 1 towards its lowered position, the blocking device being disassembled.

FIG. 3 is a perspective view of the blocking device of FIG. 2, at the point of being assembled on a lifting cylinder of the lift truck of FIG. 1.

FIG. 4 is a partial perspective view of the lifting cylinder and the lifting arm of the lift truck of FIG. 1, together with the assembled blocking device.

FIG. 5 is a view in section, perpendicular to the lifting cylinder, of the lifting cylinder together with the assembled blocking device.

FIG. 6 is a partial front view of the lift truck, showing an example of fixation of the elements of the blocking device on the chassis of the lift truck.

FIG. 7 is a partial perspective view showing in more detail the fixation shown in FIG. 6.

### DESCRIPTION OF THE EMBODIMENTS

By convention, the “longitudinal” direction of the handling machine corresponds to the front-back orientation of the machine. Furthermore, the “transverse” direction is oriented perpendicular to the longitudinal direction. In addition, the “vertical” and “horizontal” directions are defined with reference to a handling machine positioned on a perfectly horizontal plane.

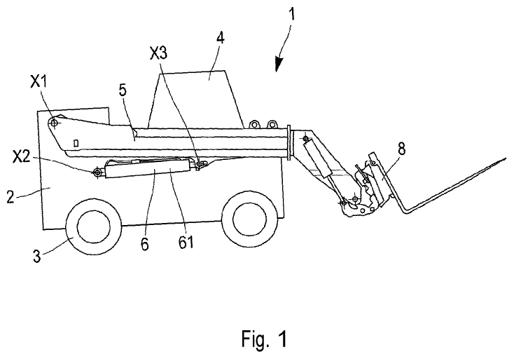

A handling machine 1 is described with reference to FIG. 1. The handling machine 1 includes a movable chassis 2. For this, the handling machine 1 includes wheels 3 or tracks, as well as a powertrain which is not shown. The powertrain comprises a combustion engine or electric motor as well as a transmission device which couples said engine or motor to the wheels 3 or to the tracks, which enables the handling machine 1 to be moved.

The handling machine 1 also includes a driver's cab 4 which is carried by the chassis 2. The driver's cab 4 is equipped with a driving station comprising a seat on which the driver can sit in order to drive the lift truck. The driving station also includes equipment for controlling the handling machine 1, such as a steering wheel, an accelerator pedal and a brake pedal. The driving station is also equipped with one or more actuating members which enable control of the movement of a lifting arm 5 and of a tool 8 which is articulated there, and which will be described in more detail below.

The lifting arm 5 is pivotably mounted on the chassis 2 about an axis X1 which is, preferably, oriented horizontally and transversely. Thus, the lifting arm 5 is mounted movable in a vertical plane parallel to the longitudinal direction of the handling machine 1 between a lowered position, illustrated in FIG. 1, and a raised position.

According to an embodiment, the lifting arm 5 is telescopic, in other words its length is variable. To achieve this, the lifting arm 5 includes at least two parts, one of which slides inside the other, and a telescoping cylinder, not illustrated, which includes a first and second end, respectively fixed to the first and the second part of the lifting arm 5. In this case, the handling machine 1 can, in particular, be a telescopic truck. According to another embodiment, the lifting arm 5 is an arm of fixed length.

The handling machine 1 also includes a lifting cylinder 6.

In a manner known per se, the lifting cylinder 6 includes a barrel (also called a cylinder body) 61 in which a rod (also called a piston) 62 is slidingly mounted. The barrel 61 is mounted articulated, at one of its ends, on the chassis 2 of the handling machine 1 about an articulation axis X2 parallel to the axis X1. The rod 62 is mounted articulated, at its opposite end from the barrel 61, on the lifting arm 5 about an articulation axis X3, also parallel to X1.

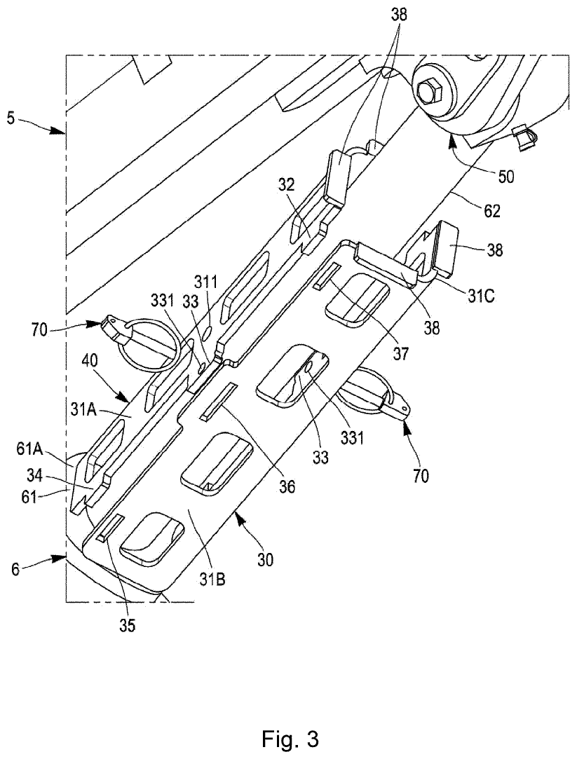

It is well known that the sliding of the rod 62 in the barrel 61 causes the passage of the lifting arm 5 from its lowered position, illustrated in FIG. 1, to a raised position, illustrated for example in FIG. 3. The rod 62 can be actuated in any desired manner, for example hydraulically, pneumatically or electrically. Of course, the actuating of the rod 62 is controlled by the driver from the driving station, in a manner known per se.

Furthermore, in a manner known per se, the lifting arm 5 is also equipped with a tool 8, such as a bucket or a fork, which is intended to receive a load. The tool 8 is mounted articulated to the distal end of the lifting arm 5. In a manner known per se and not detailed here, the tool 8 can be pivotably mounted relative to the lifting arm 5.

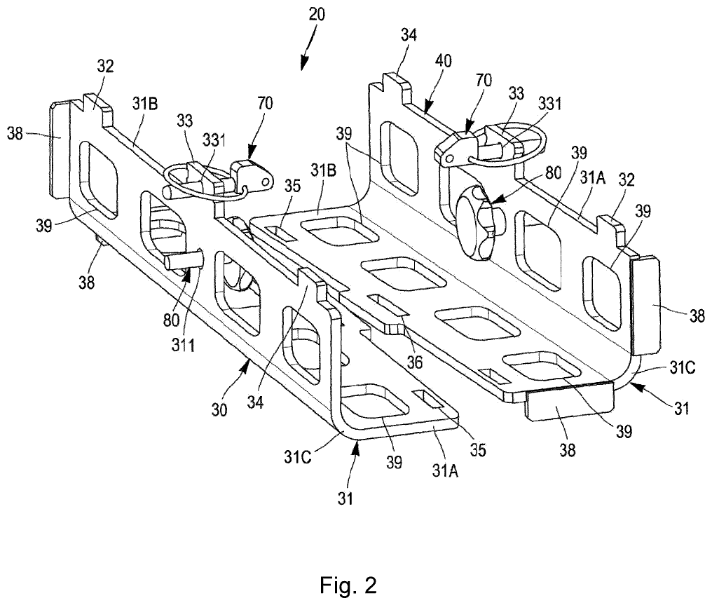

When the lifting arm 5 is raised, it may be desired to block the movement of the lifting arm 5 towards its lowered position illustrated in FIG. 1, for example in order to allow an operator to act without danger on a part of the handling machine 1 which is located under the lifting arm 5. A blocking device 20 which is suitable for blocking the movement of the lifting arm 5 towards its lowered position will now be described with reference to FIGS. 2 to 7.

Firstly, with reference to FIG. 2 and FIG. 3, the blocking device 20 comprises two blocking elements respectively designated by reference signs 30 and 40.

The blocking elements 30, 40 each include an elongate main body 31 having a generally L-shaped cross-section. More precisely, the main body 31 includes two elongate portions 31A, 31B, and the elongate portions 31A, 31B form a right-angle with respect to one another, in such a way as to form the generally L-shaped cross-section. In the example shown, the elongate portions 31A, 31B are connected together by a curved connection portion 31C.

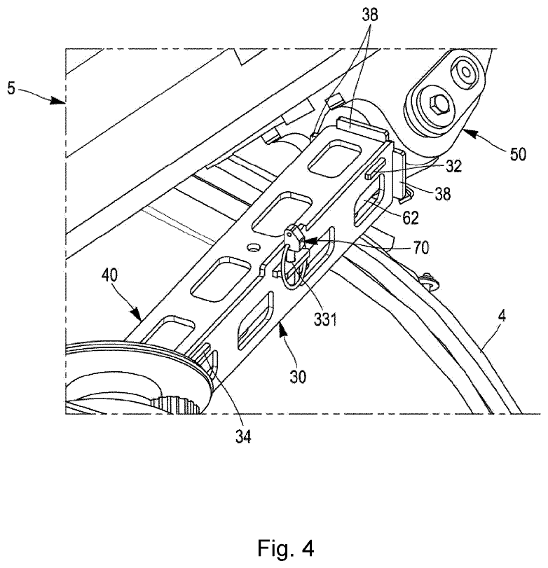

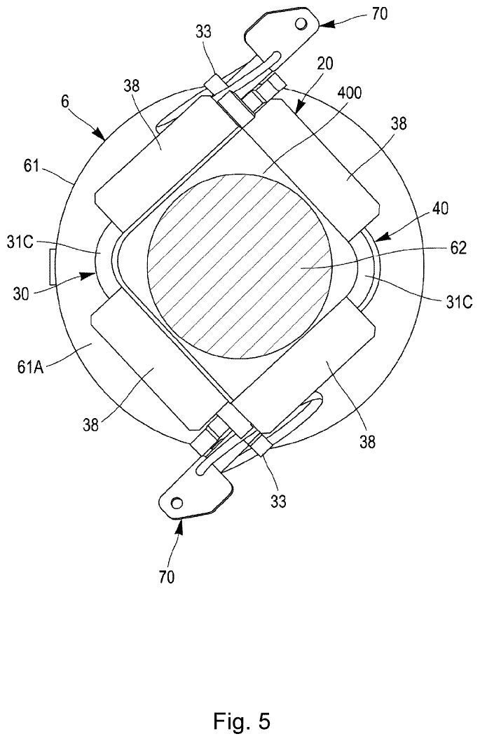

The elongate portion 31A includes tenons 32, 33, 34, while the elongate portion 31B includes mortises 35, 36, 37, shaped to respectively receive the tenons 32, 33, 34. Thus, the blocking elements 30, 40 can be assembled to one another in such a way as to produce an assembled configuration, shown in FIG. 4 and FIG. 5.

In order to retain the blocking elements 30, 40 in the assembled configuration, one of the tenons 32, 33, 34, and preferably the central tenon 33, is provided with a through-hole 331. The through-hole 331 is dimensioned to receive a pin 70 which, when it is inserted in the through-hole 331, retains the tenon 33 in place in the corresponding mortise 36.

In order to facilitate the manufacture of the blocking device 20, the blocking elements 30, 40 are preferably identical.

The blocking elements 30, 40 can be produced in any appropriate manner, as long as they have sufficient mechanical strength to block the movement of the lifting arm 5 towards its lowered position as will be described below. In a particular example, the blocking elements 30, 40 are produced by extrusion then by machining of an appropriate metal alloy.

In order to lighten the blocking elements 30, 40, the elongate portion 31A and/or the elongate portion 31B can independently include one or more apertures 39.

In addition, it is preferable that at least one of elongate portion 31A and elongate portion 31B, and preferably both, includes a plate 38 at one of its ends. The plate 38 is attached to elongate portion 31A or to elongate portion 31B in an appropriate manner, and more preferably by welding.

The use of the blocking device 20 will now be described with reference to FIGS. 3 to 5.

First, the lifting arm 5 is raised by means of the lifting cylinder 6, as has been previously described.

Then, the blocking elements 30, 40 are fetched and disposed around the rod 62, as shown in FIG. 3.

Then, the blocking elements 30, 40 are assembled by means of the tenons 32, 33, 34 and mortises 35, 36, 37, in such a way as to produce the assembled configuration of the blocking device 20. In this assembled configuration, as shown in FIG. 4 and FIG. 5, the blocking elements 30, 40 together delimit a central space 400 of sufficient dimensions to allow the rod 62 of the lifting cylinder 6 to pass.

Finally, the pins 70 are inserted in the corresponding through-holes 331 on the tenons 33, and this retains the blocking device 20 in its assembled configuration.

It is well understood that, in the assembled configuration:
at one of their ends, the blocking elements 30, 40 abut against an end surface 61A (see FIG. 3 and FIG. 5) of the barrel 61,
whereas at the other of their ends, the blocking elements 30, 40 are able to abut against the articulation bracket 50 of the lifting arm 5 (see FIG. 5). It is preferable, although not compulsory, that it is the ends which carry the attached plates 38 that are disposed facing the articulation bracket 50, since then the risk of these ends sliding on the articulation bracket 50 is less. It is specified as an alternative, that only one of the blocking elements 30, 40 could have the attached plates 38.

In any case, in this way, the lifting cylinder 6 is prevented from retracting below a minimum extension defined by the length of the elongate portions 31A, 31B, and the lifting arm 5 is thus prevented from returning towards its lowered position shown in FIG. 1. Thus, an operator can act without danger on a part of the handling machine 1 which is located under the lifting arm 5.

It is specified as an alternative, that the number of tenons 32, 33, 34 and mortises 35, 36, 37 can be different from three, provided that the blocking elements 30, 40 can be assembled to one another, as has just been described.

In addition, alternatively, the blocking elements 30, 40 can be assembled in any other suitable manner, for example using screws. The above-described assembly by means of tenons 32, 33, 34 and mortises 35, 36, 37 is however preferable, because it is particularly easy to carry out and does not require a tool.

In an alternative which is not shown, the barrel 61 can be mounted articulated on the lifting arm 5 while the cylinder 62 is mounted articulated on the chassis 2. The use of the blocking device 20 in this case is identical to that previously described.

The blocking elements 30, 40 can be carried on-board the handling machine 1 in a compartment provided for this purpose. For example, this compartment may be located in the driver's cab 4 or located on a side of the chassis 2.

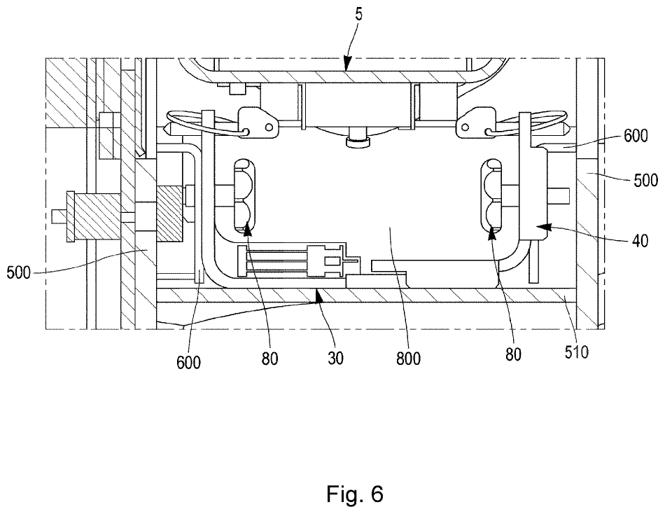

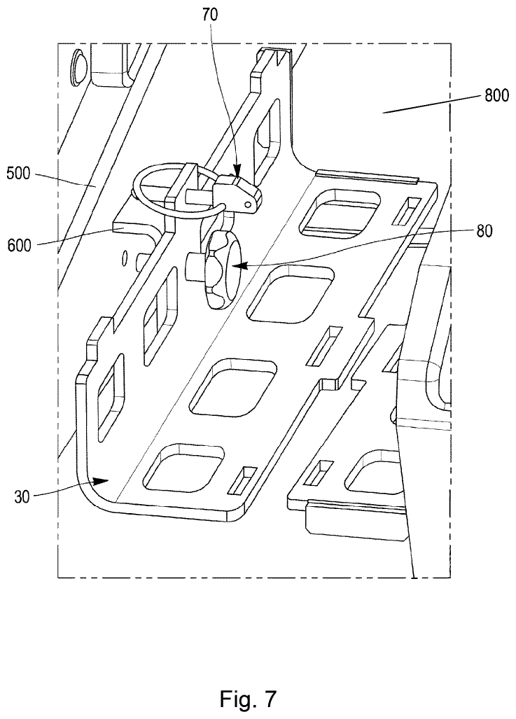

However, it is preferable that the blocking elements 30, 40 are fixed to the chassis 2 at a position which is located under the lifting arm 5 and which is accessible when the lifting arm 5 is raised. An example of fixing of the blocking elements 30, 40 according to this principle will now be described with reference to FIGS. 6 and 7.

As shown schematically in FIG. 6, the chassis 2 can include two side-members 500. The side-members 500 extend parallel to one another. In a manner known per se and not shown, the lifting arm 5 is pivotably mounted between the two side-members 500. The axis X1 is thus perpendicular to the side-members 500. The side-members 500 preferably extend parallel to the longitudinal direction of the handling machine 1, such that the axis X1 is oriented horizontally and transversely.

Still with reference to FIG. 6, a support plate 510 extends between the two side-members 500, for example perpendicular to the two side-members 500. The support plate 510 can be attached to the side-members 500 or to another element of the chassis 2. The support plate 510 is located under the lifting arm 5 when this is in its lowered position shown in FIG. 1 and FIG. 6. The support plate 510 and the side-members 500 thus delimit a space 800 (see FIG. 6) under the lifting arm 5, this space 800 becoming accessible when the lifting arm 5 is raised.

With reference to FIG. 6 and FIG. 7, a fixing plate 600, only one of which is shown in FIG. 7, is attached to each of the side-members 500 and/or to the support plate 510. The fixing plate 600 bears a through-hole (not referenced) which is shaped to receive a knurled screw 80. On the other hand, with reference to FIG. 2, each of the blocking elements 30, 40 includes a through-hole 311, here produced on the elongate portion 31A, for receiving the knurled screw 80. Thus, each of the blocking elements 30, 40 can be fixed to the chassis 2, simply by positioning the through-hole 311 opposite the through-hole of the fixing plate 600, then by inserting and tightening the knurled screw 80.

Alternatively, the blocking elements 30, 40 to the chassis 2 in the space 800 can be fixed to the side-members 500 in the space 800 in any suitable manner, for example using screws. The fixation described above by means of the knurled screw 80 and the fixing plate 600 is however preferable, because it is particularly easy to carry out and does not require a tool.

The blocking device 20 can be used for blocking a lifting cylinder incorporated in a handling machine or any other cylinder.

Although the invention has been described in conjunction with several particular embodiments, it is clearly obvious that it is in no way limited to these and that it comprises all the technical equivalents of the described means as well as their combinations if these fall within the scope of the invention.

The use of the verbs “to include” or “to comprise” and their conjugated forms does not exclude the presence of other elements or other steps than those stated in a claim.

In the claims, any reference sign between parentheses should not be interpreted as a limitation of the claim.

1. A blocking device for a cylinder, the blocking device comprising two blocking elements, each blocking element having a first end and a second end opposite the first end,
wherein the two blocking elements are configured to be assembled to one another in an assembled configuration in which the two blocking elements together delimit a central space for a rod of the cylinder,
wherein, in the assembled configuration, a distance between the first end and the second end of each of the two blocking elements defines a minimum extension of the cylinder, the minimum extension of the cylinder being attained when:
a) the first end of each of the two blocking elements abuts an end surface of a barrel of the cylinder in which the rod slides, and
b) the second end of each of the two blocking elements abuts an articulation bracket, the articulation bracket receiving an articulation shaft, an opposite end of the rod from the barrel being mounted to the articulation shaft.

2. The blocking device as claimed in claim 1, wherein each of the two blocking elements has a generally L-shaped cross-section.

3. The blocking device as claimed in claim 1, wherein each of the two blocking elements includes at least one tenon, the at least one tenon being configured to be received in a mortise that the other blocking element includes to produce the assembled configuration.

4. The blocking device as claimed in claim 3, wherein each of the two blocking elements includes three tenons, the three tenons comprising a retaining tenon, the retaining tenon having a through-hole configured to receive a pin for retaining the two blocking elements in the assembled configuration.

5. The blocking device as claimed in claim 3, wherein each of the two blocking elements further includes at least one aperture.

6. The blocking device as claimed in claim 1, wherein at least one of the two blocking elements includes, at the second end, an attached plate configured to abut against the articulation bracket.

7. The blocking device as claimed in claim 1, wherein the two blocking elements are identical.

8. A handling machine comprising:
a chassis;
a lifting arm pivotably mounted on the chassis about an axis of rotation to be movable between a lowered position and a raised position;
a lifting cylinder for pivoting the lifting arm, the lifting cylinder including: a barrel mounted to one of the chassis or the lifting arm, about a first articulation axis; and a rod mounted to slide in the barrel and mounted to the other of the chassis or the lifting arm via an articulation shaft, the articulation shaft extending along a second articulation axis parallel to the first articulation axis and being received in an articulation bracket; and
a blocking device for blocking a movement of the lifting arm towards the lowered position,
wherein the blocking device comprises two blocking elements, each blocking element having a first end and a second end opposite the first end,
wherein the two blocking elements are configured to be assembled to one another in an assembled configuration in which the two blocking elements together delimit a central space through which the rod passes,
wherein, in the assembled configuration, the first end of each of the two blocking elements abuts against an end surface of the barrel, and the second end of each of the two blocking elements is configured to abut against the articulation bracket to block the movement of the lifting arm towards the lowered position.

9. The handling machine as claimed in claim 8, wherein each of the two blocking elements has a generally L-shaped cross-section.

10. The handling machine as claimed in claim 8, wherein each of the two blocking elements includes at least one tenon, the at least one tenon being configured to be received in a mortise of the other blocking element to produce the assembled configuration.

11. The handling machine as claimed in claim 10, wherein each of the two blocking elements includes three tenons, the three tenons comprising a retaining tenon, the retaining tenon having a through-hole configured to receive a pin for retaining the two blocking elements in the assembled configuration.

12. The handling machine as claimed in claim 10, wherein each of the two blocking elements further includes at least one aperture.

13. The handling machine as claimed in claim 8, wherein at least one of the two blocking elements includes, at its second end, an attached plate configured to abut against the articulation bracket.

14. The handling machine as claimed in claim 8, wherein the two blocking elements are identical.

15. The handling machine as claimed in claim 8, wherein each of the two blocking elements is configured to be fixed to the chassis.

16. The handling machine as claimed in claim 8, wherein the chassis includes two side-members extending parallel to one another, the lifting arm being pivotably mounted between the two side-members.

17. The handling machine as claimed in claim 16, wherein at least one of the blocking elements is configured to be fixed to the chassis in a space located between the two side-members, under the lifting arm, when the lifting arm is in the lowered position.

18. A blocking device for a cylinder, the blocking device comprising:
first and second blocking elements,
wherein, in an assembled configuration, the first and second blocking elements together define a passage for a rod of the cylinder,
wherein, in the assembled configuration, a length of each blocking element defines a minimum extension of the cylinder, the minimum extension of the cylinder being reached when
the first and second blocking elements each abut an end surface of a barrel of the cylinder, and
the first and second blocking elements each abut an articulation bracket connected to the rod.

19. The blocking device as claimed in claim 18, wherein each of the first and second blocking elements has a substantially L-shaped cross-section.

20. The blocking device as claimed in claim 18, wherein each of the first and second blocking elements includes a tenon and defines a mortise, the tenons being insertable into the mortises.
